(19) United States
(12) Patent Application Publication
(10) Pub. No.: US 2024/0401806 A1
(43) Pub. Date: Dec. 5, 2024

(54) FOUR-WIRE ELECTRIC HEATING AND IGNITION DEVICE CAPABLE OF TEMPERATURE MEASUREMENT

(71) Applicant: CHONGQING LE-MARK TECHNOLOGY CO., LTD., Chongqing (CN)

(72) Inventor: Peter LEIGH, Chongqing (CN)

(21) Appl. No.: 18/695,595

(22) PCT Filed: Oct. 17, 2022
(86) PCT No.: PCT/CN2022/125555

§ 371 Date: Mar. 26, 2024

(30) Foreign Application Priority Data
May 25, 2022 (CN) 202210574075.5

(51) Int. Cl. F23Q 7/24; F23Q 7/10

(52) U.S. Cl. CPC F23Q 7/24; F23Q 7/10

(57) ABSTRACT

The present disclosure relates to the technical field of electric heating devices, and provides a four-wire electric heating and ignition device capable of temperature measurement, for solving the problem that a high-temperature hot surface element used in the existing combustion/heating apparatuses is prone to have a heating/ignition fault during use, which causes the combustion apparatuses to be unable to operate normally. The device includes a housing and a heating assembly having a self-temperature measurement function; the heating assembly is located in the housing, and the heating assembly extends out of a heating end of the housing; a temperature measurement end of the housing is further provided with a temperature measurement assembly, and a temperature measurement end of the temperature measurement assembly extends out of the temperature measurement end of the housing.

### CROSS-REFERENCE TO RELATED APPLICATIONS

This application is a national stage entry application under 35 U.S.C. 371 of PCT Patent Application No. PCT/CN2022/12555, filed on Oct. 17, 2022, which claims priority to Chinese Patent Application No. 202210574075.5 filed on May 25, 2022, the entire contents of each of which are incorporated herein by reference.

### TECHNICAL FIELD

The present disclosure relates to the technical field of electric heating/ignition devices, and specifically, to a four-wire electric heating and ignition device capable of temperature measurement.

### BACKGROUND

A combustion apparatus refers to an apparatus that ignites and burns fuel and converts the chemical energy of the fuel into thermal energy to be released. Currently, most green new energy combustion apparatuses use fuel such as methanol or LNG for combustion. During the use of a combustion apparatus, a high-temperature hot surface element may also be used for direct ignition. However, when the described ignition technology is used, due to large changes in ambient temperature, gas flow rate, fuel/air temperature, etc., an ignition fault tends to occur, and normal combustion cannot be performed, thereby affecting normal operation of a combustion apparatus.

### SUMMARY

The present disclosure is intended to provide a four-wire electric heating and ignition device capable of temperature measurement, for solving the problem that a high-temperature hot surface element used in the existing combustion apparatuses is prone to have a heating/ignition fault during use, which causes the combustion apparatuses to be unable to operate normally.

The present disclosure, in an embodiment, provides the following solution: a four-wire electric heating and ignition device capable of temperature measurement, including a housing and a heating assembly having a self-temperature measurement function; the heating assembly is located in the housing, and the heating assembly extends out of a heating end of the housing; a temperature measurement end of the housing is further provided with a temperature measurement assembly, and a temperature measurement end of the temperature measurement assembly extends out of the temperature measurement end of the housing.

Beneficial effects of the solution are: during the process of use of a high-temperature hot surface element, a great change in ambient temperature would have a large effect on the temperature of the high-temperature hot surface element, thereby causing the problem of heating/ignition fault. Thus, in this solution, the heating assembly having a self-temperature measurement function is used as a heating core of the electric heating device, and the temperature measurement assembly extending out of the housing is also used as a cold end (a temperature measurement end) to perform auxiliary temperature measurement; auxiliary temperature measurement compensates for a temperature measurement error caused by unstable external environment, and the conjunctive use of a temperature control system can ensure that correction is timely performed when the temperature of the cold end changes, thereby improving the heating/ignition reliability of the electric heating device, thus ensuring normal use of a combustion device.

Further, in an embodiment, the temperature measurement assembly is a thermocouple wire.

Beneficial effect: in this solution, a thermocouple wire is used as a temperature measurement assembly, allowing for a simple structure.

Further, in an embodiment, the temperature measurement assembly is a metal thermocouple wire. Further, in an embodiment, the heating assembly includes a temperature-measurable heating element. Beneficial effects: in this solution, a temperature-measurable heating assembly is used as a heating assembly, improving the temperature control response speed and the service life, and the heating assembly achieves a thermocouple temperature measurement function by means of distribution of materials thereof, allowing for a simple structure.

Further, in an embodiment, the heating assembly further includes two electrodes, and electrode leads extending out of the housing are connected to the electrodes. Beneficial effect: in this solution, the electrodes and the electrode leads lead a power supply end out of the housing, thereby facilitating the supply of power, outside the housing, to the heating assembly.

Further, the housing is a metal housing or a ceramic housing.

### BRIEF DESCRIPTION OF THE DRAWINGS

FIG. 1 is a schematic diagram of a four-wire electric heating and ignition device capable of temperature measurement according an embodiment of the present invention.

### DETAILED DESCRIPTION OF THE EMBODIMENTS

The following gives more details by means of exemplary embodiments:

Reference signs in the drawing accompanying the description include: temperature-measurable heating element 1, central electrode 2, side electrode 3, housing 4, central electrode lead 5, temperature measurement assembly 6, and side electrode lead 7.

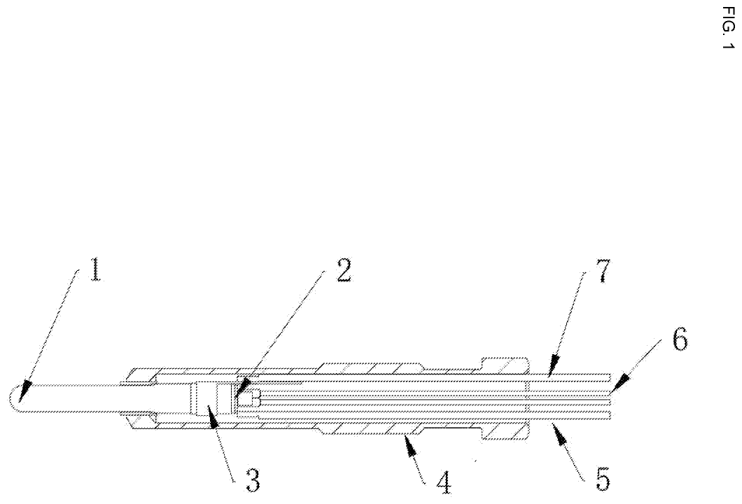

An embodiment is basically as shown in FIG. 1: a four-wire electric heating and ignition device capable of temperature measurement, comprising a housing 4 and a heating assembly having a self-temperature measurement function. In this embodiment, the housing 4 is a metal housing or a ceramic housing, and a metal housing is used in this embodiment. The left end of the housing 4 is a heating end, and the right end of the housing is a temperature measurement end, that is, a cold end of the electric heating device.

The heating assembly is located in the housing 4, and the heating assembly extends out of the heating end of the housing 4. In order to achieve a self-temperature measurement function of the heating assembly, in this embodiment, the heating assembly includes a temperature-measurable heating element 1, and the temperature-measurable heating element 1 achieves a thermocouple temperature measurement function by means of distribution of materials thereof. In this embodiment, the temperature-measurable heating element 1 is a silicon nitride full ceramic heating element.

The heating assembly further includes two electrodes, and electrode leads extending out of the housing are connected to the electrodes. Specifically, in this embodiment, the two electrodes include a central electrode 2 and a side electrode 3, wherein a central electrode lead 5 extending out of the housing 4 is connected to the central electrode 2, and a side electrode lead 7 extending out of the housing 4 is connected to the side electrode 3. In the present embodiment, the central electrode 2 has functions of both electric conduction and serving as a positive electrode of the electric heating device, and the side electrode 3 has functions of both electric conduction and serving as a negative electrode of a temperature measurement thermocouple.

The temperature measurement end of the housing 4 is further provided with a temperature measurement assembly 6, and a temperature measurement end of the temperature measurement assembly 6 extends out of the temperature measurement end of the housing 4. The temperature measurement assembly 6 is a pair of metal thermocouples.

One specific implementation process is as follows: when in use, the side electrode lead 7 is connected to a negative electrode of a power supply, the central electrode lead 5 is connected to a positive electrode of the power supply, and the power supply supplies power to the electric heating device. After the heating assembly is electrified, the heating assembly generates heat at a high temperature, and achieves a function of thermocouple temperature measurement by means of distribution of materials thereof. At the same time, the temperature measurement assembly 6 is electrified; the temperature measurement assembly 6 is led out of the electric heating device, therefore the temperature measurement assembly 6, after being electrified, performs auxiliary temperature measurement on the cold end of the electric heating device, so as to compensate for a temperature measurement error caused by external instability.

In this embodiment, the heating assembly having a self-temperature measurement function is used as a heating core of the electric heating device, and a metal thermocouple is used as a cold end to perform auxiliary temperature measurement, achieving composite functions of electric conduction, heating, and temperature control, overcoming the problem that the existing burners do not allow for 100% reliable ignition and stable working condition operation under usage of methanol and LNG fuel conditions, thereby ensuring normal operation of a combustion apparatus.

What is described is merely an embodiment of the present disclosure, and common knowledge such as specific structures and characteristics which are well-known in the solution is not described here too much. A person skilled in the art is aware of all the common technical knowledge and have access to all the technologies existing before the filing date or the priority date in the technical field to which the disclosure pertains, and has capacity to apply all the routine experimental means before that date. With the motivation provided in the present application and by combining same with self-capability, a person skilled in the art can improve and implement the present solution, and some typical well-known structures or well-known methods should not become a barrier to the implementation of the present application for a person skilled in the art. It should be noted that, a person skilled in the art can further make various modifications and improvements without departing from the structure of the present disclosure, and these modifications and improvements should also be considered as belonging to the scope of protection of the present disclosure, and these modifications and improvements do not affect the effect of the implementation of the present disclosure and the applicability of patent. The scope of protection of the present application shall be subject to the content of the claims, and the disclosure in the description such as specific embodiments can be used to interpret the content of the claims.

1. A four-wire electric heating and ignition device capable of temperature measurement, comprising:
a housing having a heating end and a temperature measurement end;
a heating assembly having a self-temperature measurement function wherein the heating assembly is located in the housing, and the heating assembly extends out of the heating end of the housing;
a temperature measurement assembly, wherein the temperature measurement assembly extends out of the temperature measurement end of the housing.

2. The four-wire electric heating and ignition device capable of temperature measurement according to claim 1, wherein the temperature measurement assembly is a thermocouple wire.

3. The four-wire electric heating and ignition device capable of temperature measurement according to claim 2, wherein the temperature measurement assembly is a metal thermocouple wire.

4. The four-wire electric heating and ignition device capable of temperature measurement according to claim 1, wherein the heating assembly comprises a temperature-measurable heating element.

5. The four-wire electric heating and ignition device capable of temperature measurement according to claim 4, wherein the heating assembly further comprises two electrodes, and electrode leads extending out of the housing are connected to the electrodes.

6. The four-wire electric heating and ignition device capable of temperature measurement according to claim 5, wherein the housing is a metal housing or a ceramic housing.
